(19) United States
(12) Patent Application Publication
(10) Pub. No.: US 2014/0278997 A1
(43) Pub. Date: Sep. 18, 2014

(54) ELECTRONIC ADVERTISING SYSTEM AND METHOD OF PROVIDING ELECTRONIC ADVERTISING

(71) Applicants: Nobuyuki KISHI, Tokyo (JP); Jun MURATA, Tokyo (JP); Yumiko MURATA, Tokyo (JP); Takayuki KUNIEDA, Tokyo (JP)

(72) Inventors: Nobuyuki KISHI, Tokyo (JP); Jun MURATA, Tokyo (JP); Yumiko MURATA, Tokyo (JP); Takayuki KUNIEDA, Tokyo (JP)

(73) Assignee: Ricoh Company, Limited, Tokyo (JP)

(21) Appl. No.: 14/202,450

(22) Filed: Mar. 10, 2014

(30) Foreign Application Priority Data
Mar. 15, 2013 (JP) 2013-054410

(51) Int. Cl. G06Q 30/02

(52) U.S. Cl. CPC G06Q 30/0258
USPC 705/14.56

(57) ABSTRACT

An electronic advertising system includes: a registration unit configured to register, in association with indexes by which objects advertised by a first advertiser included in images are retrieved, advertising information advertised by a second advertiser; a reception unit configured to receive a captured image; an object search unit configured to obtain degree of similarity between an object extracted from the captured image and the objects retrieved by the indexes, and to search a storage unit for one or more objects based on the degree of similarity; and a present unit configured to present, to a transmission source of the captured image, the advertising information associated with an index corresponding to an object retrieved by the object search unit.

### CROSS-REFERENCE TO RELATED APPLICATIONS

The present application claims priority to and incorporates by reference the entire contents of Japanese Patent Application No. 2013-054410 filed in Japan on Mar. 15, 2013.

### BACKGROUND OF THE INVENTION

1. Field of the Invention

The present invention relates to an electronic advertising system and a method of providing electronic advertising that present an advertisement through the Internet.

2. Description of the Related Art

A large amount of money is required for publication of an advertisement to a paper medium. Especially, the publication of an advertisement to a newspaper or a magazine having high advertising effect devotes a limited page space. Therefore, large advertisers mainly use the publication of an advertisement for products/services, and use rights of the spaces are held by the large advertisers. Therefore, small third advertisers who have accompanying products/services related to the main advertising objects have difficulty in easily using the paper space. Therefore, as an advertising means for the small third advertisers who have the accompanying products/services to perform advertising, internet advertising to present advertising through the Internet is known.

Japanese Patent Application Laid-open No. 2003-108862 discloses a configuration in which an information display space such as printing is provided in a part of a package, the space is provided to the third parties through a communication network such as the Internet and an advertisement is sought, a synergistic effect obtained from the advertisement is evaluated from registered medium information and advertising product information, and package advertising dealing between the side who allows the publication of the advertisement and the side who wishes the publication of the advertisement is mediated. According to the configuration of Japanese Patent Application Laid-open No. 2003-108862, effective use of the display space of the package is enhanced, and sales synergistic effect of both advertising products can be obtained.

However, in the conventional internet advertising, while a small advertiser who is the third party can present an advertisement of the accompanying products/services through the Internet, the advertisement is a single advertisement in a place not led to an advertisement of the large advertiser using the paper medium. Therefore, there is a problem that the small advertiser as the third party who has the accompanying products/services has difficulty in performing the internet advertising using the advertising effect of the main products/services as the synergistic effect.

This problem that the advertisement of the accompanying products/services by the small advertiser presented through the Internet is not led to the advertisement of the large advertiser using the paper medium and is the single advertisement has not been solved by Japanese Patent Application Laid-Open No. 2003-108862.

In view of the foregoing, there is a need to present an advertisement by a second advertiser presented through the Internet in association with an advertisement by a first advertiser using a paper medium.

### SUMMARY OF THE INVENTION

It is an object of the present invention to at least partially solve the problems in the conventional technology.

An electronic advertising system includes: a registration unit configured to register, in association with indexes by which objects advertised by a first advertiser included in images are retrieved, advertising information advertised by a second advertiser; a reception unit configured to receive a captured image; an object search unit configured to obtain degree of similarity between an object extracted from the captured image and the objects retrieved by the indexes, and to search a storage unit for one or more objects based on the degree of similarity; and a present unit configured to present, to a transmission source of the captured image, the advertising information associated with an index corresponding to an object retrieved by the object search unit.

A method of providing electronic advertising comprising: registering advertising information advertised by a second advertiser in association with indexes for searching for objects advertised by a first advertiser included in images; receiving a captured image; obtaining degree of similarity between an object extracted from the captured image and the objects retrieved by the indexes, and searching a storage unit for one or more objects based on the degree of similarity; and presenting, to a transmission source of the captured image, the advertising information associated with an index corresponding to an object retrieved at the searching.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of an example of an image search system according to an embodiment;

FIGS. 2A and 2B are diagrams illustrating examples of image data that are bases of index data stored in a DB according to an embodiment;

FIGS. 3A and 3B are diagrams illustrating configurations of an example of a DB according to an embodiment;

FIG. 4 is a diagram illustrating an example of an XML code according to an embodiment;

FIG. 5 is a flowchart illustrating an example of an operation of a server according to an embodiment;

FIG. 6 is a flowchart illustrating an example of present processing of linkage information of an index according to an embodiment;

FIG. 7 is a flowchart illustrating an example of processing of prompting a user to perform processing of selecting one index from among a plurality of indexes according to an embodiment;

FIG. 8 is a diagram schematically illustrating a configuration of an electronic advertising system according to an embodiment;

FIG. 9 is a block diagram illustrating a configuration of an example of an advertising right dealing mediation system according to an embodiment in more detail;

FIG. 10 is a diagram illustrating a configuration of an example of a registration screen through which a first advertiser registers an advertising right to the electronic advertising system according to an embodiment;

FIG. 11 is a diagram illustrating an example of an advertising right sales setting screen according to an embodiment;

FIG. 12 is a diagram illustrating a table according to an embodiment, in which a business operator name and the type of business are associated with each other;

FIG. 13 is a flowchart illustrating an example of advertising registration processing according to an embodiment;

FIG. 14 is a flowchart illustrating an example of a method of purchasing an advertising right according to an embodiment;

FIG. 15 is a diagram illustrating an example of an advertising right search screen according to an embodiment, which is displayed in a terminal device;

FIG. 16 is a diagram for describing an example of displaying advertising information using a mobile terminal according to an embodiment;

FIG. 17 is a diagram for describing an example of displaying advertising information using a mobile terminal according to an embodiment;

FIG. 18 is a diagram for describing an example of reading an image of a printed matter by an MFP, and printing and outputting another advertising information and advertising information related to the read image; and

FIG. 19 is a diagram for describing an example of reading an image of a printed matter by an MFP, and printing and outputting another advertising information and advertising information related to the read image.

### DETAILED DESCRIPTION OF THE PREFERRED EMBODIMENTS

Hereinafter, embodiments of an electronic advertising system and a method of providing electronic advertising will be described in detail with reference to the appended drawings.

Image Search System Applicable to Embodiments

Prior to description of embodiments, an image search system applicable to embodiments will be described for easy understanding. The image search system extracts an object from a captured image captured by an image capturing device, compares the extracted object and objects stored in a database in advance, and identifies an object having the highest degree of similarity to the object extracted from the captured image. Then, link information of a commercial site associated with the identified object in advance and the like are presented to the user.

FIG. 1 is a diagram illustrating a configuration of an example of an image search system according to an embodiment. An image recognition server 11 and a terminal device 20 are connected to a network 10. The network 10 is, for example, the Internet, and a transmission control protocol/Internet protocol (TCP/IP) is applied as a communication protocol. The network 10 includes a plurality of computers mutually connected through the network, and may be a network cloud that is a network group to/from which only an input/output is presented to/from an outside as a black box that conceals its inside.

Further, a plurality of commercial sites 30A and 30B are connected to the network 10. These commercial sites 30A and 30B can ship a product in response to an order made through the network 10.

The terminal device 20 can perform communication with the network 10 in a wireless or wired manner. The terminal device 20 can perform an operation according to an instruction received through the network 10, and can display an image received through the network 10 to a user interface (UI) including a display device and an input device and can transmit data to the network 10 according to an user operation made to the UI.

Further, the terminal device 20 includes an image capturing function, and can capture an image of a subject in response to an image capturing instruction operation to the UI. The terminal device 20 can transmit a captured image obtained by the capturing to the network 10.

The image recognition server 11 is connected with a database (DB) 12, and can perform search processing to the DB 12 according to a request received through the network 10. Here, index data for searching for a plurality of image data 50A and 50B are respectively stored in the DB 12 in association with linkage information. The index data is data obtained through an analysis of a binary of the image data, and is data converted from the image data in a structure for searching.

Note that the image data can be directly stored in the DB 12. A file name and a path of the image data may be stored in the DB 12.

The image recognition server 11 receives the image data through the network 10, searches the DB 12 based on the received image data, and acquires the linkage information corresponding to the image data as a search result. The server returns the linkage information acquired as the search result to a transmission source of the image data.

Note that the image recognition server 11 can be configured from a typical computer device including a central processing unit (CPU), a random access memory (RAM), a read only memory (ROM), and a storage device such as a hard disk drive. Further, the image recognition server 11 is not limited to a configuration made of a single computer device, and may be configured to operate in a plurality of computer devices in a distributed manner.

FIGS. 2A and 2B illustrate examples of the image data 50A and 50B that are bases of the index data stored in the DB 12. Here, an object included in the image data will be defined. The object refers to an image that serves as a main object in an image by the image data, and is an image distinguished from a background image of the main object and accompanying information of the main object in the image.

As an example, the image data 50A and 50B are a contents page that is the contents of a catalogue magazine, and a cover page that is a cover of the catalogue magazine, respectively. FIG. 2A illustrates an example of the image data 50A by an image 130A of the contents page, and FIG. 2B illustrates an example of the image data 50B by an image 130B of the cover page.

FIG. 2A is an example in which a single object 131 is arranged in a central part of the image 130A. In the image 130A, a target region 134 including the object 131 is set to the object 131. FIG. 2A is an example in which the ratio of the size of the object 131 to the size of the target region 134 is small. In the case of the catalogue magazine, the contents page is intended to introduce the product. Therefore, the object 131 that is an image indicating the product is displayed large with respect to the contents page.

FIG. 2B is an example in which a plurality of objects 132 and 133 is arranged in the image 130B. Here, the object 132 is a reduced image of the object 131 illustrated in FIG. 2A, and the object 133 is another image. More objects may be arranged in the image 130B. In this example, the objects 132 and 133 included in the contents page are reduced and displayed as thumbnails in the display page so that the contents of the catalogue magazine are summarized and shown. In the image 130B, a target region 135 is set to include the objects 132 and 133, and to cover the entire cover page (image data 130B).

Note that the target regions 134 and 135 are used as indexes for recognizing the objects 131, 132, and 133. The target region includes the entire object, and can be set to any size smaller than an overall image including the object.

The linkage information will be described. The linkage information is, for example, information indicating a function to link up with the object included in the image, to be specific, information including a method of accessing attribute information of the object. Therefore, in reality, the linkage information can be considered to be stored in the DB 12 in association with the object included in the image.

As an example, in the object 131 included in the image 130A of the contents page, the linkage information is a uniform resource locator (URL) of the commercial site 30A that handles a product indicated by the object 131, or a URL of a purchase page in which purchase setting of the product is performed. Not only the above, a telephone number and a mail address of a store that handles the product may be used as the linkage information. Further, information for downloading a data file including information of the product may be used as the linkage information. Note that, in the DB 12, a plurality of pieces of linkage information can be associated with a single object.

As another example, a URL of a site and the like on the network 10, which introduces the catalogue magazine itself including the cover page, can be used as the linkage information with respect to the objects 132 and 133 included in the image 130B of the cover page.

In such a configuration, the user captures an image of the page of the catalogue magazine using the terminal device 20, for example, and acquires a captured image 40A or 40B. In this example, the captured images 40A and 40B are captured images of the contents page and the cover page of the catalogue magazine, respectively. The user transmits the captured image 40A to the image recognition server 11 through the network 10, for example.

The captured image 40A is received by the image recognition server 11. The image recognition server 11 detects characteristic points of the received captured image 40A, and extracts an object based on the characteristic points. Further, the image recognition server 11 calculates the degrees of similarity between the object included in the captured image 40A and objects retrieved by indexes stored in the DB 12 based on the detected characteristic points. The image recognition server 11 searches the DB 12 for an index based on the calculation result. The image recognition server 11 retrieves the linkage information from the DB 12 based on a search output, and presents the linkage information to the terminal device 20 that is a transmission source of the captured image 40A.

The user can access the commercial site 30A based on the linkage information presented from the image recognition server 11 to the terminal device 20, and can purchase the product indicated by the object included in the captured image 40A.

Here, in FIG. 2A, assume that an image including an object that resembles closely to the object 131 included in the image 130A is captured by the terminal device 20 as the captured image 40A, for example. Further, assume that the image 130A including the object 131, and the image 130B including the object 132 that is the reduced object 131 are stored in the DB 12.

In this case, as a result of a search based on the degree of similarity calculated from a detection result of the characteristic points of the captured image 40A, there is a possibility that the image 130B is retrieved instead of the image 130A. In this case, the user cannot acquire desired linkage information. To prevent such a situation, a search of an image stored in the DB 12 is performed based on a ratio of the size of the target region (captured range) and the size of the object.

More specific description will be given with reference to FIGS. 2A and 2B. In the image 130A exemplarily illustrated in FIG. 2A, the object 131 is arranged to occupy a large space with respect to the image 130A, and the target region 134 is set to the object 131, being slightly larger than the size of the object 131. Meanwhile, in the image 130B exemplarily illustrated in FIG. 2B, the object 132 that is the reduced object 131 is arranged, and the target region 135 is set to the entire image 130B, that is, set to sufficiently larger size than that of the object 132.

In the image 130A, a value of a first ratio of the size of the object 131 to the size of the target region 134, which is obtained based on the areas, is ½. In contrast, in the image 130B, a value of a second ratio of the size of the object 132 to the size of the target region 135, which is obtained based on the areas is 1/16, and the value is substantially different from the value in the case of the image 130A. Note that the method of obtaining the ratio of size is not limited to the method based on the areas. Such information indicating the ratios of size can be obtained in advance, and included in the index and stored in the DB 12.

Further, as for the captured image 40A received from the terminal device 20, it can be considered to obtain a ratio of the size of the extracted object to the size of the captured image 40A itself. For example, assume that the captured image 40A is an image like the image 130A of FIG. 2A, and a third ratio of the size of the object (the object 131) to the size of the captured image 40A is, for example, ¼.

In this case, the third ratio is closer to the first ratio than to the second ratio described above. Therefore, the image recognition server 11 outputs an index corresponding to the image 130A as a result of a search result to the captured image 40A. The image recognition server 11 presents, to the terminal device 20, the linkage information associated with the index corresponding to the image 130A. As described above, the index is selected based on the ratio of the size of the object to the image size, whereby a desired index can be more accurately selected.

FIGS. 3A and 3B illustrate configurations of an example of the DB 12 for realizing processing of searching for an image based on the ratio of the size of the object. FIG. 3A illustrates an example of an index table 120 for identifying each index data stored in the DB 12. Each index data is stored in the DB 12 such that an ID and binary data of the index data are associated with each other, as exemplarily illustrated in FIG. 3A.

The format of the ID is not especially limited as long as the ID can identify each index data stored in the DB 12. When the index data stored in the DB 12 is data for searching for an object of each page of the catalogue magazine, a value including a number of the page in which the object appears can be used as the ID.

FIG. 3B illustrates an example of an target region table 121 that associates an ID of an image and a target region. In this example, the target region is described using an extensible markup language (XML) that is one type of the markup language that defines and describes meaning and a structure of data using a tag. While described below, description of the linkage information is also embedded to the description of the target region. An XML code with which the target region is described may be directly stored in a field of the target region table 121, or may be separately described in a file, and a file name and a path may be described in the field.

FIG. 4 illustrates an example of an XML code 140 illustrated in FIG. 3B. The XML code 140 illustrated in FIG. 4 is an example of describing a target region of a certain contents page of the catalogue magazine. A portion sandwiched by the outermost tags “<page>” and “</page>” defines the page. Each of portions sandwiched by the tags “<hotspot>” and “</hotspot>” in portions 141₁ and 141₂ defines a single target region. As described above, a plurality of target regions can be defined with respect to a single page.

In the portion 141₁, the first row 142 indicates that a range in the page of the target region is defined by coordinates of an upper left corner (x1, y1) and coordinates of a lower right corner (x2, y2), for example, by the portion sandwiched by the tags “<area>” and “</area>”.

In each of the portions 143₁ and 143₂, one piece of linkage information is defined by the portion sandwiched by the tags “<link>” and “</link>”. As described above, a plurality of pieces of linkage information can be defined to a single target region. In the portion 143₁, the title of the linkage information is defined by the portion sandwiched by the tags “<title>” and “</title>”. The type of the linkage information is defined by the portion sandwiched by the tags “<type>” and “</type>”. Further, in the example, address information on the network 10 is defined by the portion sandwiched by the tags “<URI>” and “</URI>” as the linkage information.

As described above, the target region in the page and the linkage information in the target region are defined by the XML code 140. Therefore, the function by the linkage information associated with the object included in the target region in the page can be executed.

FIG. 5 is a flowchart illustrating an example of an operation of the image recognition server 11. First, the captured image 40A obtained by being captured by the terminal device 20 is transmitted to the image recognition server 11 through the network 10. In step S100, the image recognition server 11 receives the captured image 40A. In next step S101, the image recognition server 11 performs an image analysis of the received captured image 40A, detects a characteristic point, and extracts an object.

In next step S102, the image recognition server 11 calculates a ratio of the size of the object to the size of the captured image 40A. Note that, regarding each image stored in the DB 12, the ratio of the size of the object to the size of the target region is calculated in advance. Information indicating the ratio of each image stored in the DB 12 can be embedded in the above-described XML code 140.

In next step S103, the image recognition server 11 compares the object extracted from the captured image 40A and objects retrieved by the indexes stored in the DB 12. To be specific, the image recognition server 11 calculates the degrees of similarity between the object included in the captured image 40A and the objects retrieved by the indexes stored in the DB 12.

In next step S104, the image recognition server 11 determines whether there is an index by which an object that is in accord with the object included in the captured image 40A is retrieved, among the indexes stored in the DB 12, based on the degrees of similarity calculated in step S103. In this example, an object in which the degree of similarity is a threshold or more, among the objects retrieved by the indexes included in the DB 12, is determined to be an index by which the object that is in accord with the object included in the captured image 40A is retrieved.

When it has been determined in step S104 that there is an index by which an object is in accord, the image recognition server 11 transfers the processing to step S105. In step S105, the image recognition server 11 determines whether objects is in accord by a plurality of indexes among the indexes stored in the DB 12. When it has been determined that an object is in accord by only a single index, the image recognition server 11 transfers the processing to step S107 described below employing the single index as a search output. Meanwhile, when it has been determined that objects are in accord by a plurality of indexes, the image recognition server 11 transfers the processing to step S106.

In step S106, the image recognition server 11 obtains ratios of the sizes of a plurality of objects retrieved by the plurality of indexes to the size of the target region. The ratios related to the plurality of objects may be obtained in advance and stored in the DB 12. Along with that, regarding the captured image 40A, the image recognition server 11 obtains a ratio of the size of the object to the size of the captured image 40A. Then, the image recognition server 11 obtains a ratio closest to the ratio obtained about the captured image 40A from among the ratios obtained about the plurality of objects, selects an index for searching for an object corresponding to the obtained ratio and employs the index as a search output, and transfers the processing to step S107.

In step S107, the image recognition server 11 retrieves the linkage information corresponding to the index of the search output from the DB 12. The image recognition server 11 then presents the retrieved linkage information to the terminal device 20 that is a transmission source of the captured image 40A. Then, the series of processing by the flowchart of FIG. 5 ends.

Note that, when it has been determined that there is no index in accord in the above-described step S104, the processing is transferred to step S108, and the image recognition server 11 presents, to the terminal device 20, a massage indicating that no index in accord is stored in the DB 12. Then, the series of processing by the flowchart of FIG. 5 ends.

FIG. 6 is a flowchart illustrating an example of processing of presenting the linkage information of an index in step S107 of FIG. 5. The image recognition server 11 first, in step S200, identifies a target region corresponding to the captured image 40A in the object retrieved by the index of the search output in step S105. In next step S201, the image recognition server 11 refers to the DB 12, and determines whether there is linkage information associated with the identified target region. When there is linkage information, the image recognition server 11 transfers the processing to step S202, and determines whether a plurality of pieces of linkage information is associated with the target region.

When having determined that a plurality of pieces of linkage information is associated with the target region in step S202, the image recognition server 11 transfers the processing to step S203. In step S203, the image recognition server 11 creates a function list indicating functions by the plurality of pieces of linkage information, and presents, to the terminal device 20, a selection screen for selecting a function from the function list. For example, when a URL and a telephone number are associated with the identified target region as the linkage information, for example, the image recognition server 11 creates a selection screen for selecting a function to access an address indicated by the URL and a telephone function to the telephone number, and presents the selection screen to the terminal device 20. Then, the series of processing by the flowchart of FIG. 6 ends.

Meanwhile, in step S202, when having determined that only one piece of linkage information is associated with the target region, the image recognition server 11 transfers the processing to step S204. In step S204, the image recognition server 11 creates a screen for causing a function by the one piece of linkage information to execute, and presents the screen to the terminal device 20. Then, the series of processing by the flowchart of FIG. 6 ends.

Note that, in the above-described step S201, when having determined that linkage information is not associated with the target region identified in step S200, the image recognition server 11 transfers the processing to step S205. In step S205, the image recognition server 11 presents a specific screen determined in advance to the terminal device 20. Then, the series of processing by the flowchart of FIG. 6 ends.

In the above-description, the image recognition server 11 side selects one index from among a plurality of indexes in step S106. However, the processing is not limited to the example. That is, the user can be prompted to perform the processing of selecting one index from among a plurality of indexes.

FIG. 7 is a flowchart illustrating an example of processing of prompting the user to perform the processing of selecting one index from among a plurality of indexes by a search output in step S105. In the above-described step S105 of FIG. 5, when having determined that objects are in accord with the object included in the captured image 40A by a plurality of indexes, the image recognition server 11 transfers the processing to step S106′ illustrated in FIG. 7.

When the processing has been transferred to step S106′, the image recognition server 11 generates a screen for presenting, to the user, information indicating the plurality of indexes that has been determined to be in accord in step S300, and presents the screen to the terminal device 20. For example, it can be considered that the image recognition server 11 generates a screen for displaying an image of an object retrieved by each of the plurality of indexes, and presents the screen to the terminal device 20.

The image recognition server 11 waits for reception of a selection result of one index (object image) from among the plurality of indexes (object images) from the terminal device 20 (step S301). When having received, from the terminal device 20, selection of one index from among the plurality of indexes presented in step S300, the image recognition server 11 selects, in step S302, one object image from among the plurality of object images in which the indexes have been determined to be in accord, according to a reception result. Then, the image recognition server 11 retrieves, from the DB 12, the linkage information associated with the index by which the selected object is retrieved, and presents the linkage information to the terminal device 20.

As described above, the user can more accurately select a desired image by being presented a plurality of images.

Electronic Advertising System According to Embodiment

Next, an electronic advertising system according to an embodiment will be described. In an electronic advertising system according to an embodiment, index data for searching for an object (image) on an advertisement provided by a first advertiser in a paper medium is registered in association with advertising information provided by a second advertiser, using the above-described image search system.

Accordingly, in an embodiment, the advertising information by the second advertiser is retrieved from a captured image obtained by capturing an image of the advertisement provided by the first advertiser in a paper medium. Therefore, for example, the advertising information by the second advertiser that is a small advertiser can be easily associated with an advertisement in a paper medium by the first advertiser that is a large advertiser.

Further, the first advertiser can make a profit by selling, to the second advertiser, an advertising right to associate, by the second advertiser, the advertising information with an index for searching for an object on an advertisement provided in a paper medium.

FIG. 8 schematically illustrates a configuration of an electronic advertising system according to an embodiment. In FIG. 8, the electronic advertising system includes an advertising right dealing mediation system 1, a contents management server 4, and an image search system 5. The image search system 5 corresponds to the image search system described with reference to FIGS. 1 to 7. Further, the contents management server 4 includes the DB 12 of FIG. 1. The advertising right dealing mediation system 1 mediates sales of an advertising right to associate information with an advertisement, by the first advertiser 2, and a purchase of the advertising right, by the second advertiser 3.

The first advertiser 2 publishes an advertisement in a paper medium such as a magazine, and registers a right in which a third party associates advertising information with index data for searching for an object on the advertisement (hereinafter, referred to as advertising right) to the advertising right dealing mediation system 1 (step S1). At this time, the first advertiser 2 registers a search requirement for searching for the advertising right, a method of selling the advertising right, a suggested selling price of the advertising right, and the like to the advertising right dealing mediation system 1 as parameters.

The second advertiser 3 accesses the advertising right dealing mediation system 1, searches for an advertising right to associate the advertising information provided by the second advertiser 3 (step S2). When a desired advertising right has been retrieved, the second advertiser 3 can purchase the advertising right. Information indicating purchase determination is transmitted to the advertising right dealing mediation system 1.

When having purchased the advertising right, the second advertiser 3 provisionally registers, to the advertising right dealing mediation system 1, the advertising information to be associated with the index of the purchased advertising right (step S3). The advertising information may be image data or text data, or may be link information by a uniform resource locator (URL). The advertising right dealing mediation system 1 temporarily holds the provisionally registered advertising information.

When having confirmed the advertising information provisionally registered in step S3, the advertising right dealing mediation system 1 transmits the advertising information to the contents management server 4, and formally registers the advertising information (step S4). At this time, the advertising right dealing mediation system 1 can present the advertising information to the first advertiser 2, and inquire whether association of the advertising information with the index data is approved (step S5). When the result is “negative”, the advertising right dealing mediation system 1 notifies the second advertiser 3 of the fact, and does not perform the formal registration of the advertising information.

When having formally registered the advertising information, the advertising right dealing mediation system 1 notifies the second advertiser 3 of the fact of the registration (step S6).

With the configuration of the electronic advertising system, a user different from the first advertiser 2 and the second advertiser 3 transmits, to the image search system 5, a captured image obtained by capturing an image of an advertisement provided by the first advertiser 2 in a paper medium. The image search system 5 extracts an object from the captured image, and searches the contents management server 4 for an index corresponding to the extracted object, as described with reference to FIGS. 1 to 7 (step S7). When the index has been retrieved, the image search system 5 acquires the advertising information associated with the retrieved index from the contents management server 4 (step S8), and transmits the advertising information to the user. The user can acquire the advertising information by the second advertiser 3 based on the advertisement by the first advertiser 2 in the paper medium.

FIG. 9 illustrates a configuration of an example of the advertising right dealing mediation system 1 according to an embodiment in more detail. The advertising right dealing mediation system 1 includes a dealing management unit 200, an advertising right management unit 210, a dealing information database (DB) 220, an advertising right DB 221, and a contents DB 222, and a communication unit 223. Further, the advertising right dealing mediation system 1 is connected with the contents management server 4 and the image search system 5 through a network 230, and is also connected with a charging system 231.

The communication unit 223 performs communication with a terminal device used by the first advertiser 2 or the second advertiser 3. When having received a communication request from the terminal device of the first advertiser 2 or of the second advertiser 3, the communication unit 223 performs communication with an authentication server (not illustrated), and performs authentication processing of the terminal device.

For example, when the communication unit 223 performs communication between the terminal device and the advertising right dealing mediation system 1, the communication unit 223 requests the terminal device to input user identification information for identifying the user (the first advertiser 2 or the second advertiser 3). The communication unit 223 performs the authentication processing with the authentication server using the user identification information transmitted from the terminal device, and when the authentication is succeeded, the communication unit 223 allows access from the terminal device, from which the user identification information has been transmitted, to the advertising right dealing mediation system 1.

The dealing management unit 200 includes a purchase management unit 201 and a sales management unit 202. The dealing management unit 200 stores information related to the advertising right to be sold and purchased in the dealing information DB 220, and manages the information. The sales management unit 202 manages information indicating the first advertiser 2 who sells the advertising right, and information related to the advertising right to be sold by the first advertiser 2. The information related to the advertising right includes, for example, information indicating the index data corresponding to the advertising right, a suggested selling price of the advertising right, a method of selling the advertising right (an auction or an offer), information indicating the type of business or an organization body that is to serve as a sales target of the advertising right.

The purchase management unit 201 manages information of the second advertiser 3 who wishes purchase of the advertising right, and information related to the advertising right purchased by the second advertiser 3. For example, the second advertiser 3 registers own information to the purchase management unit 201 in advance. Only the second advertiser 3 who has been registered in the purchase management unit 201 can execute the purchase of the advertising right.

The advertising right management unit 210 includes an advertising right generation unit 211, a value determination unit 212, and a log management unit 213. The advertising right generation unit 211 refers to the index data for searching for an object on an advertisement by the first advertiser 2 in a paper medium, from the image search system 5, and generates information indicating the advertising right for associating the advertising information with the referred index data. The information includes, for example, information indicating a location of the index data, and information indicating whether the association of the advertising information with the index data is allowed. The generated information indicating the advertising right is stored in the advertising right DB 221.

In the contents DB 222, the advertising information by the second advertiser 3, which is to be associated with the index data for searching for an object on an advertisement by the first advertiser 2 in a paper medium, is managed. As described above, the another advertising information and the advertising information are, for example, URLs. The log management unit 213 acquires and manages log information related to accesses to the URLs indicated by the another advertising information and the advertising information. The value determination unit 212 determines a value of the advertising information based on the log information managed by the log management unit 213.

The charging system 231 performs charging processing when the second advertiser 3 has purchased the advertising right to associate the advertising information with the index data for searching for an object on an advertisement by the first advertiser 2 in a paper medium. Further, the charging system 231 can perform the charging processing to the second advertiser 3 according to the number of accesses to the URL indicated by the advertising information based on the log information managed by the log management unit 213. Further, the charging system 231 can perform the charging processing to the first advertiser 2 or to the second advertiser 3 according to the number of accesses to the URL indicated by the another advertising information or the URL indicated by the advertising information based on the log information.

Next, processing of registering the advertising right according to an embodiment will be described. FIG. 10 illustrates an example of a configuration of a registration screen used when the first advertiser 2 registers the advertising right to the electronic advertising system according to an embodiment. An advertising registration screen 300 illustrated in FIG. 10 is, for example, generated by the advertising right generation unit 211 in the advertising right management unit 210 of the advertising right dealing mediation system 1. For example, the advertising right generation unit 211 generates display control information for displaying the advertising registration screen 300 in the terminal device using a hypertext markup language (HTML) or the like. For example, the first advertiser 2 performs communication with the communication unit 223 and performs authentication processing using the terminal device, thereby to access the display control information.

In FIG. 10, on the advertising registration screen 300, a contents display section 301, a link setting button 320, a contents setting button 321, an advertising right sales setting button 322, and a determination button 323 are arranged. Further, the contents display section 301 is displayed in the terminal device, in which contents display sections 310A and 310B, an advertising information display section 311, and an another advertising information display section 312 are arranged.

In the contents display sections 310A and 310B, contents by the first advertiser 2, which are an object to be advertised in a paper medium, are displayed. In the advertising information display section 311, the advertising information to be registered by the second advertiser 3, which is to be associated with the index data for searching for an object displayed in the contents display sections 310A and 310B, is displayed. Further, in the another advertising information display section 312, another advertising information by the first advertiser 2, which is to be associated with the index data, is displayed. As described above, according to an embodiment, the another advertising information of the first advertiser 2 can be associated with the index data, in addition to the advertising information of the second advertiser 3.

The link setting button 320 is a button for inputting and editing the another advertising information displayed in the another advertising information display section 312. By an operation of the link setting button 320, an edit screen (not illustrated) for inputting and editing the another advertising information is displayed. The another advertising information is stored in the contents DB 222 in association with search data for searching for contents #1 and contents #2 displayed in the contents display sections 310A and 310B.

The contents setting button 321 is a button for setting an object to be advertised by the first advertiser 2. As an example, when the contents setting button 321 is operated, a file display screen in the terminal device or in an environment connected with the terminal device through the network is displayed (not illustrated). The file display screen may be displayed in a hierarchical structure using folders. The first advertiser 2 selects a desired file (image data) through the file display screen, so that the selected file is transmitted from the terminal device to the advertising right dealing mediation system 1, and the file is uploaded.

When the file is normally uploaded, display of the contents display sections 310A and 310B is updated, and an image (object) by the uploaded file is displayed in the contents display sections 310A and 310B.

The advertising right sales setting button 322 is a button for setting parameters such as a requirement when the advertising right regarding the object displayed in the contents display sections 310A and 310B is sold. FIG. 11 illustrates an example of the advertising right sales setting screen according to an embodiment, which is displayed when the advertising right sales setting button 322 is operated. In FIG. 11, an advertising right sales setting screen 330 is displayed in the terminal device, in which a sales method selection section 331, a type of business setting section 332, a business operator name setting section 333, and a determination button 334 are arranged.

The sales method selection section 331 selects a method of selling the advertising right. In the example of FIG. 11, an auction and an offer are mutually exclusively selectable. In the sales method selection section 331, either the auction or the offer is set in advance in a default state. When the offer is selected, an input screen for inputting a suggested selling price is further displayed (not illustrated). The input screen may be added to the advertising right sales setting screen 330 and displayed.

The type of business setting section 332 sets the type of business desired as the second advertiser 3 to serve as a sales target of the advertising right. It can be considered that the type of business is set based on large categories of products such as clothes, bags, household appliance, and real estate. The categories are not limited to the above example, and may be set based on subdivided categories such as audio/visual (AV) equipment, major appliance, and health equipment, in the case of the household appliance. Information of the type of business is set in advance, for example, and it can be configured such that the list is displayed when the first advertiser 2 operates the button arranged in the right end of the type of business setting section 332. Further, in the example of FIG. 11, two types of business can be set to one advertising right. As described above, the type of business of the sales target of the advertising right can be set. Therefore, information related to a product advertised in a paper medium by the first advertiser 2 can be set as the advertising information, whereby enhancement of an effect of advertising can be expected.

The business operator name setting section 333 sets a business operator name of the second advertiser 3 specifically. A plurality of the business operator names of the second advertisers 3 can be set to one advertising right. The information of the type of business is set in advance, for example, and it can be configured such that, when the first advertiser 2 operates the button arranged in the right end of the business operator name setting section 333, the list is displayed.

Further, as exemplarily illustrated in FIG. 12, a table in which the business operator name and the type of business are associated with each other may be created in advance. By use of the table, the type of business is automatically determined when the business operator name is selected. Therefore, the setting operation in the type of business setting section 332 can be omitted. In this table, comments and the like may be registered to each piece of information as the another information.

The determination button 334 determines the content set in the sales method selection section 331, the type of business setting section 332, and the business operator name setting section 333 upon an operation, and transmits the determined setting content to the advertising right dealing mediation system 1. The setting content is received by the advertising right dealing mediation system 1, passed to the dealing management unit 200, and stored in the dealing information DB 220.

FIG. 13 is a flowchart illustrating an example of an advertising registration processing according to an embodiment using the advertising registration screen 300 and the advertising right sales setting screen 330. Prior to the execution of the processing by the flowchart of FIG. 13, the first advertiser 2 performs communication with the communication unit 223 through the terminal device, and performs the authentication processing. When the authentication is succeeded, by a predetermined operation to the terminal device, the advertising registration screen 300 is displayed in the terminal device.

First, in step S10, the contents setting button 321 is operated by the first advertiser 2, and the registration processing of the object (image data) to be used by the first advertiser 2 for an advertisement provided in a paper medium to the advertising right generation unit 211 is performed. For example, the object selected through the file display screen is transmitted from the terminal device to the advertising right dealing mediation system 1, and is supplied to the advertising right generation unit 211. The advertising right generation unit 211 grants identification information to the registered object.

Note that the index data for searching for the object is registered in the DB 12 of the image search system 5 in advance or in step S10.

In next step S11, the advertising right sales setting button 322 is operated by the first advertiser 2, and the advertising right sales setting screen 330 exemplarily illustrated in FIG. 11 is displayed in the terminal device.

The first advertiser 2 sets parameters for selling the advertising right according to the display of the advertising right sales setting screen 330. With the operation of the determination button 334, the set content is transmitted to the advertising right dealing mediation system 1, passed to the dealing management unit 200, stored in the dealing information DB 220 in association with the identification information that identifies the first advertiser 2 and the identification information that identifies the registered object, and registered as the dealing information (step S12).

When the dealing information is registered in step S12, in next step S13, the advertising right generation unit 211 refers to the index data for searching for an object on an advertisement in the paper medium by the first advertiser 2 from the image search system 5, and generates information indicating the advertising right for associating the advertising information with the referred index data. The information indicating the advertising right includes, for example, the identification information that identifies the first advertiser 2, the identification information that identifies the registered object, and information that allows association of the advertising information by the second advertiser 3 with the index data for searching for the object. In next step S14, the advertising right generation unit 211 stores the information indicating the advertising right generated in step S13 in the advertising right DB 221, and registers the advertising right.

Next, a method of purchasing the advertising right by the second advertiser 3 will be described. FIG. 14 is a flowchart illustrating an example of a method of purchasing the advertising right according to an embodiment. Prior to the execution of the processing by the flowchart of FIG. 14, the second advertiser 3 performs communication with the communication unit 223 through the terminal device, and performs the authentication processing. When the authentication is succeeded, with a predetermined operation to the terminal device, an advertising right search screen is displayed in the terminal device.

FIG. 15 illustrates an example of an advertising right search screen 340 according to an embodiment, which is displayed in the terminal device. On the advertising right search screen 340, a business operator name input section 341 that inputs a business operator name, a type of business input section 342 that inputs the type of business, and a search button 343 that instructs a search start are arranged. The second advertiser 3 operates the search button 343 after performing an input to at least one of the business operator name input section 341 and the type of business input section 342. Note that the business operator name input section 341 and the type of business input section 342 may be able to be selected from business operator names and the types of business registered in advance.

When the search button 343 is operated, information input to the business operator name input section 341 and the type of business input section 342 and the instruction of the search start are transmitted from the terminal device to the advertising right dealing mediation system 1, and are received by the communication unit 223. The communication unit 223 passes the received business operator name, type of business, and search start instruction to the dealing management unit 200. The dealing management unit 200 searches the dealing information DB 220 for the advertising right according to the search start instruction using the business operator name and the type of business (step S20).

The dealing management unit 200 generates, according to a search result, display control information for displaying a purchase determination screen accompanying the display contents of the contents display section 301 in the advertising registration screen 300 illustrated in FIG. 10 and a button that instructs purchase determination. The display control information is transmitted from the communication unit 223 to the terminal device. The terminal device displays the purchase determination screen according to the received display control signal.

The advertising information by the second advertiser 3 can be input to a part on the purchase determination screen, which is corresponding to the advertising information display section 311 of FIG. 10. For example, the second advertiser 3 can input an URL of the advertising information to the part corresponding to the advertising information display section 311. At this time, when the URL of the advertising information indicates the location of the image data, the image data can be displayed in the part corresponding to the advertising information display section 311.

In next step S21, the dealing management unit 200 waits for transmission of a purchase determination instruction from the terminal device. When having received the purchase determination instruction from the terminal device, the dealing management unit 200 transfers the processing to step S22, and performs provisional registration of the advertising right. In the provisional registration of the advertising right, the dealing management unit 200 passes the identification information that identifies the second advertiser 3, the information indicating the business operator name and the business operator retrieved in step S20, and the provisionally registered right information including the URL of the advertising information to the advertising right management unit 210. The advertising right management unit 210 temporarily holds the passed provisionally registered right information in the advertising right DB 221.

Note that, in a case of the auction, the selling price is further displayed as the search result of the advertising right, and the processing of steps S20 and S21 is repeated until the selling price becomes an acceptable price for the second advertiser 3.

When the provisional registration of the advertising right has been completed in step S22, the dealing management unit 200 transfers the processing to next step S23. In step S23, the dealing management unit 200 notifies the first advertiser 2 of the fact of a purchase request of the advertising right. The notification can be made using an electronic mail, for example. When having received the notification, the first advertiser 2 confirms the provisionally registered advertising information. As an example, when the notification is made using an electronic mail, it can be considered that the linkage information to the advertising registration screen 300 on which the advertising information is displayed in the advertising information display section 311 is embedded in the electronic mail. At this time, it is more favorable to display information of the second advertiser 3 who has wished the purchase of the advertising right (the identification information, the business operator name, and the type of business, and the like) in the advertising information display section 311.

The first advertiser 2 confirms the advertising registration screen 300 on which the advertising information is displayed in the advertising information display section 311, and notifies the advertising right dealing mediation system 1 of whether allowing the purchase request of the advertising right (step S24). When having received notification of not allowing the purchase request, the advertising right dealing mediation system 1 terminates the series of processing by the flowchart of FIG. 14. At this time, it is favorable to notify the second advertiser 3 who has wished the purchase of the advertising right of the fact that the purchase request has not been allowed.

Meanwhile, when having received notification of the fact that the purchase request of the advertising right has been allowed in step S24, the advertising right dealing mediation system 1 transfers the processing to step S25. In step S25, the advertising right dealing mediation system 1 formally registers the advertising right provisionally registered in step S22. Here, the formal registration of the advertising right is performed such that the advertising right management unit 210 stores the URL of the advertising information in the contents DB 222 in association with the index data for searching for an object by the first advertiser 2.

In next step S26, information to the dealing information DB 220 is registered. That is, in the advertising right dealing mediation system 1, the advertising right management unit 210 passes the dealing information of the provisionally registered right information temporarily held in the advertising right DB 221 in step S22 to the dealing management unit 200. The dealing management unit 200 stores the passed provisionally registered right information in the dealing information DB 220.

In next step S27, the advertising right dealing mediation system 1 sets the charging processing to the second advertiser 3, and the series of processing by the flowchart of FIG. 14 ends.

Next, application examples of the embodiment will be described. FIGS. 16 and 17 illustrate examples of displaying advertising information using a mobile terminal. As illustrated in FIG. 16, an image 401 of an advertisement by the first advertiser 2 in a paper medium is captured using a mobile terminal 400 having an image capturing function and a communication function (see FIG. 16A). Image data of the captured image is transmitted to the image search system 5. The image search system 5 extracts an object from the image data and searches for corresponding index data, as described above. The retrieved index data is passed to the advertising right DB 221 and the contents DB 222 as illustrated by the path 240 of FIG. 17. The index data transmitted to the advertising right DB 221 is held as log information, for example.

The advertising right management unit 210 acquires another advertising information and advertising information associated with the index data from the contents DB 222. The advertising right management unit 210 returns the acquired another advertising information and advertising information to the image search system 5. The image search system 5 transmits these pieces of another advertising information and advertising information to the mobile terminal 400. Accordingly, the another advertising information by the first advertiser 2 and the advertising information by the second advertiser 3 are displayed in the mobile terminal 400.

In the example of FIG. 16, a plurality of pieces of advertising information 402 is associated with the index data for searching for the object by the first advertiser 2 (see FIG. 16B). The user appropriately selects and operates the plurality of pieces of advertising information 402 from the mobile terminal 400, thereby to see information 403A, 403B, and 403C associated with the plurality of pieces of advertising information 402 (see FIG. 16C).

Another application example of the embodiment will be described. FIGS. 18 and 19 are examples of reading out an image of a printed matter by a multi-function printer (MFP) and printing and outputting another advertising information and advertising information related to the read image. In an MFP 250 in FIG. 18, a print function, a scanner function, a facsimile function, and the like are executable in a single housing. Further, the MFP 250 has a communication function and a browser function, and when having received a URL, the MFP 250 can access the received URL, and print an image displayed by the URL.

The user reads a printed matter 410 (for example, one page of a magazine) in which an object by the first advertiser 2 is arranged, as illustrated in FIG. 18A, using the scanner function of the MFP 250 (see FIG. 18B). Scanned image data of the read image is transmitted to the image search system 5, as illustrated in FIG. 19.

The image search system 5 extracts an object from the image data, and searches for corresponding index data, as described above. The retrieved index data is passed to the advertising right DB 221 and the contents DB 222, as illustrated by the path 240 of FIG. 19. The index data sent to the advertising right DB 221 is held as log information, for example.

The advertising right management unit 210 acquires another advertising information and advertising information associated with the index data from the contents DB 222. The advertising right management unit 210 returns the acquired another advertising information and advertising information to the image search system 5. The image search system 5 transmits the another advertising information and the advertising information to the MFP 250. The MFP 250 accesses URLs indicated by the another advertising information and the advertising information, and prints and outputs images displayed by the URLs as advertising images 410′ and 411 (see FIG. 18C). Note that, in the MFP 250, which image of the URL indicated by the another advertising information or the advertising information is selected can be designated by the user.

The embodiment provides an advantageous effect that an advertisement by a second advertiser presented through the Internet can be presented in association with an advertisement by a first advertiser using a paper medium.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. An electronic advertising system comprising:
a registration unit configured to register, in association with indexes by which objects advertised by a first advertiser included in images are retrieved, advertising information advertised by a second advertiser;
a reception unit configured to receive a captured image;
an object search unit configured to obtain degree of similarity between an object extracted from the captured image and the objects retrieved by the indexes, and to search a storage unit for one or more objects based on the degree of similarity; and
a present unit configured to present, to a transmission source of the captured image, the advertising information associated with an index corresponding to an object retrieved by the object search unit.

2. The electronic advertising system according to claim 1, further comprising:
a setting unit configured to allow access based on first identification information identifying the first advertiser, and to set a requirement for registering the advertising information by the registration unit.

3. The electronic advertising system according to claim 2, further comprising:
a requirement search unit configured to allow access based on second identification information identifying the second advertiser, and to search for the requirement,
wherein the registration unit allows registration of the advertising information when a purchase instruction by the second advertiser has been accepted according to a search result of the requirement search unit.

4. The electronic advertising system according to claim 2, wherein the setting unit sets at least information indicating a type of business and information indicating an organization body of the second advertiser as the requirement.

5. The electronic advertising system according to claim 1, wherein the object advertised by the first advertiser is printed on a paper medium and provided.

6. The electronic advertising system according to claim 1, wherein the advertising information includes image information.

7. The electronic advertising system according to claim 1, wherein the advertising information includes link information.

8. The electronic advertising system according to claim 1, wherein the registration unit further associates another advertising information advertised by the first advertiser with an index.

9. The electronic advertising system according to claim 1, wherein the registration unit is capable of registering a plurality of pieces of the advertising information for one second advertiser.

10. A method of providing electronic advertising, the method comprising:
registering advertising information advertised by a second advertiser in association with indexes for searching for objects advertised by a first advertiser included in images;
receiving a captured image;
obtaining degree of similarity between an object extracted from the captured image and the objects retrieved by the indexes, and searching a storage unit for one or more objects based on the degree of similarity; and
presenting, to a transmission source of the captured image, the advertising information associated with an index corresponding to an object retrieved at the searching.

11. The method according to claim 10, further comprising:
allowing access based on first identification information identifying the first advertiser, and, according to the access, setting a requirement for registering the advertising information by the registration unit.

12. The method according to claim 11, further comprising:
allowing access based on second identification information identifying the second advertiser, and, according to the access, searching for the requirement,
wherein registration of the advertising information at the registering is allowed when a purchase instruction by the second advertiser has been accepted according to a search result at the searching for the requirement.

13. The method according to claim 11, wherein at least information indicating a type of business and information indicating an organization body of the second advertiser is set as the requirement at the setting.

14. The method according to claim 10, wherein the object advertised by the first advertiser is printed on a paper medium and provided.

15. The method according to claim 10, wherein the advertising information includes image information.

16. The method according to claim 10, wherein the advertising information includes link information.

17. The method according to claim 10, wherein another advertising information advertised by the first advertiser is further associated with an index at the registering.

18. The method according to claim 10, wherein a plurality of pieces of the advertising information can be registered for one second advertiser at the registering.
